(19) United States
(12) Patent Application Publication
(10) Pub. No.: US 2007/0088540 A1
(43) Pub. Date: Apr. 19, 2007

(54) Voice data processing method and device

(75) Inventors: Toshiyuki Ohta, Fukuoka (JP); Kazuhiro Nomoto, Fukuoka (JP); Kano Asada, Fukuoka (JP); Kazunari Hirakawa, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/341,563

(22) Filed: Jan. 26, 2006

(30) Foreign Application Priority Data
Oct. 19, 2005 (JP) 2005-304871

(51) Int. Cl. G10L 19/00

(52) U.S. Cl. 704/216

(57) ABSTRACT

In a voice data processing method and device detecting a pitch from history data during a packet loss and generating compensating data thereof, input signal data is decoded in a normal mode, a calculation of a normalized cross-correlation in coarse search used for a pitch detection is repeated by a predetermined frequency of loops within a required frequency of loops, based on history decode data, a peak value of a normalized cross-correlation obtained by the calculation and a delay data value corresponding thereto are held, and fine search is executed by repeating the calculation of the normalized cross-correlation in the coarse search by a remaining required frequency of loops, by using the peak value of the normalized cross-correlation and the delay data value in a packet loss mode, thereby generating compensating data.

### BACKGROUND OF THE INVENTION

1. Field of the Invention

The present invention relates to a voice data processing method and device, and in particular to a voice data processing method and device for a VoIP communication system which mounts thereon the voice codec G.711 Appendix I with a packet loss compensating function and transmits voice data over an IP network.

2. Description of the Related Art

FIG. 7 shows a prior art voice data processing method by the above-mentioned G.711 Appendix I (see non-patent documents 1 and 2 below). This prior art example is provided with, as shown in FIG. 7, a decoder 1 inputting encoded data, a history buffer 2 accumulating past data decoded by the decoder 1, a packet loss compensator 3 executing packet loss compensation to PCM data decoded which is stored in the history buffer 2 and outputting compensating data C when a packet loss flag G indicates a packet loss mode, a delay portion 4 matching timings of the compensating data C with that of the PCM data outputted from the history buffer 2, and an output port 5 sequentially outputting the PCM data from the delay portion 4 and the compensating data C from the packet loss compensator 3. It is to be noted that the delay portion 4 merely passes data without a delay operation when the packet loss flag is “H” (normal mode).

Also, the packet loss compensator 3 includes a pitch detector 30, which is composed of a coarse search processor 31 and a fine search processor 32. In this packet loss compensator 3, the pitch detector 30 sequentially executes coarse search (at step S100) and fine search (at step S200) as shown in FIG. 8 by normal voice data having been received before a packet loss and stored in the history buffer 2, so that a pitch detection is performed. Repetitive substitution of a voice waveform is performed to a pitch pattern for a part corresponding to a packet loss time interval, so that the compensating data C during the packet loss is generated.

The generated compensating data C is weighted at the packet loss time to achieve smoothness. When packet losses sequentially occur, the compensating data is gradually attenuated.

Operations of FIG. 7 will now be conceptually described referring to FIGS. 9 and 10.

Firstly, by a packet loss flag G provided from an upper system, the packet loss compensator 3 recognizes a normal mode/packet loss mode (normal mode or packet loss mode). It is assumed in this description that “H” indicates the normal mode, while “L” indicates the packet loss mode.

The decoder 1 always performs decoding for every frame (10 ms), so that data decoded by the decoder 1 is stored in the history buffer 2 for every 80 samples (10 ms), as shown in FIG. 9. The history buffer 2 has a size of 390 samples as shown in FIG. 10. Since the decoded data of the decoder 1 is shifted by every frame, frames F1-F5 are stored in the history buffer 2 as shown in FIG. 10.

At the timing of a frame F6 where a packet loss has occurred, the packet loss compensator 3 executes packet loss compensation by using decoded data of the normal frames F1-F5 (for 390 samples) stored in the history buffer 2, and detects a pitch P to generate the compensating data C during the packet loss.

The hatched portions during the packet loss in FIG. 10 show data actually used for pitch detection at the pitch detector 30. As seen from FIG. 10, the data of the frames F2-F5 (for 280 samples) stored in the history buffer 2 before a loss of the frame F6 is used for the pitch detection.

Namely, this pitch detection is performed, as shown in FIG. 9, in the packet loss section of the frame F6. By performing a calculation for obtaining a peak value (bestcorr) of a normalized cross-correlation between data (corresponding to a reference signal L in FIG. 9) of 20 ms (for the frames F4 and F5) immediately before the packet loss and data (corresponding to a reference signal R in FIG. 9) for two frames (for a half of the frame F2, the frame F3, and a half of the frame F4) preliminarily stored in the history buffer 2, a pitch P is obtained.

An autocorrelation between a signal delayed by the maximum pitch (120 samples) from the reference signal L and a signal delayed by the minimum pitch (40 samples), and the cross-correlation between each of the delay signals R and the reference signal L are calculated, in which the calculation of the normalized cross-correlation is given by the following equation:
Normalized cross-correlation=cross-correlation/\sqrt{autocorrelation} (1)

In order to reduce a pitch detection load in the pitch detector 30, the processing is separated into main two stages. Firstly, as shown in FIGS. 7 and 8, the coarse search (at step S100) for obtaining a coarse normalized cross-correlation is performed at the rate of once per two samplings. Secondly, fine normalized cross-correlation is calculated in the vicinity of the peak detected by the coarse search, which is the fine search (at step S200). By performing this fine search, an accurate pitch P is calculated.

FIG. 11 shows a coarse search flow of the packet loss mode executed by the coarse search processor 31 in the pitch detector 30.

Firstly, the reference signal L and the delay signal R are set (at step S1). An autocorrelation “energy” and a cross-correlation “corr” are calculated (at step S2_2) at the rate of once per two samplings (at step S2_3), and the product-sum calculation is respectively performed 80 times (for 160 samples) (at step S2_4) (at step S2: steps S2_1-S2_4).

From the calculated autocorrelation value “energy” and the cross-correlation value “corr”, based on the above-mentioned equation (1), a normalized cross-correlation value “corr” is obtained (at step S3). This value is set to a cross-correlation initial value “bestcorr” (at step S4). Also, the delay data value “bestmatch” is initialized to “0” (at step S4).

In the loop of the subsequent normalized cross-correlation calculation (j<PITCH_DIFF: at step S50), the reference signal L and the delay signal R are also used. While the delay signal R is shifted by every sample, the autocorrelation calculation (at step S6) and the cross-correlation calculation (at steps S7 and S8) are performed to obtain the normalized cross-correlation (at step S9). By 80 samples (at step S120), the peak value “bestcorr” of the normalized cross-correlation calculation value “corr” and the delay data value “bestmatch” at this point (j) are obtained (at steps S10 and S11).

In this case, the calculation is performed by the frequency of a difference PITCHDIFF between a Pmax (120) and a Pmin (40), that is the frequency (80 times) of loops required (at steps S14 and S120).

As another prior art technology, an error concealment apparatus and method are mentioned, by which a plurality of algorithms for concealing errors are prepared in order to enable various error concealment technologies to be dynamically selected and applied, the error concealment is performed by using any one of the algorithms, an algorithm to be selected is determined by a selection signal, and the selection signal is made based on various parameters indicating throughput of a computer and a characteristic of a voice signal (see e.g. patent document 1).

Also, as still another prior art technology, a pitch detection method and device in a packet loss compensation are mentioned, by which a correlation calculation is always performed by a pitch buffer, a correlation calculating portion, and a correlation buffer, a pitch is detected, and interpolating data is prepared for loss of a subsequent frame. When a frame loss occurs, lost voice data is immediately interpolated by interpolation processing for input data (see e.g. patent document 2).

[Non-patent document 1] ITU-T TELECOMMUNICATION STANDARDIZATION SECTOR OF ITU G.711

[Non-patent document 2] ITU-T TELECOMMUNICATION STANDARDIZATION SECTOR OF ITU G.711 Appendix I (09/99)

[Patent Document 1] Japanese Patent Application Laid-open No.2003-218932

[Patent Document 2] Japanese Patent Application Laid-open No.2004-239930

The whole processing amount in the above-mentioned packet loss compensator 3 is about 39 MHz. The pitch detection occupies 29 MHz, the 75% of the whole processing amount, in which especially only the coarse search processor occupies 23 MHz, a high rate of about 60% of the whole pitch detection amount.

This is affected by the fact that the product-sum calculation is performed 81 times, the product-difference calculation is performed once, and the division calculation is performed once in a single loop, as shown in FIG. 11, that a calculation portion of double loops exists, and that multiplication processings are performed 3200 times only in that calculation portion.

Since the processing amount is only about 1 MHz in the normal mode where no packet loss occurs, as for the throughput of G.711 Appendix I type decoder, there has been a possibility of affecting the operation during the packet loss depending on a system incorporated therein to cause a malfunction or an operation halt.

In addition, when such a packet loss occurs immediately after signals decoded have continued at a silent level, the compensating data should be inevitably silent. However, in the prior art system, there has been a problem of unnecessary packet loss compensation being performed even when a signal decoded continues at a silent level.

### SUMMARY OF THE INVENTION

It is accordingly an object of the present invention to provide a voice data processing method and device detecting a pitch based on history data during a packet loss and generating compensating data thereof, whereby a calculation amount in a packet loss mode is reduced and unnecessary packet loss compensation is avoided when a signal is a silence signal.

In order to achieve the above-mentioned object, a voice data processing method (device) according to the present invention comprises: a first step (means), in a normal mode, decoding input signal data, repeating a calculation in coarse search used for a pitch detection by a predetermined frequency of loops within a required frequency of loops, based on history decode data, and holding a peak value of a normalized cross-correlation obtained by the calculation and a delay data value corresponding thereto; and a second step (means), in a packet loss mode, executing the pitch detection by repeating a calculation of a normalized cross-correlation in the coarse search by a remaining required frequency of loops, by using the peak value of the normalized cross-correlation and the delay data value, thereby generating compensating data.

Namely, in a pitch detection during the packet loss, both of coarse search and fine search have been conventionally executed (at steps S100 and S200 of FIG. 8). However, according to the present invention, a part of the coarse search that is a part of the pitch detection whose processing load executed in a packet loss mode is large is preliminarily and separately processed in a normal mode, thereby suppressing a processing amount in the packet loss mode.

This is schematically shown by a flowchart in FIG. 1. The pitch detection is executed not only in the packet loss mode but also in the normal mode, so that the processing is separated. Specifically, the coarse search within the pitch detection is separately performed in the normal mode as well as the packet loss mode. The part of the coarse search (up to the middle of the processing) in the normal mode (at step 101), namely a normalized cross-correlation calculation is executed by a predetermined frequency of loops (repetition frequency) within a required frequency of loops (the number of loops corresponding to the number of samples from a maximum delay pitch to a minimum delay pitch for a reference signal as shown in FIG. 9), based on history decode data.

A peak value bestcorr_tmp of the normalized cross-correlation within the coarse search obtained by the calculation, and a delay data value bestmatch_tmp at this time are held in e.g. a buffer (not shown) as variables (at step S102). In the packet loss mode, with the variables (at step S103), the remaining coarse search is performed (at step S104), and then the processing is taken over to the fine search (at step S200).

As a result, by separating the processing into the normal mode, the processing amount in the packet loss mode can be reduced. Also, since the frequency of loops in the coarse search given in the normal mode can be variably set by a user or the like, the processing amount of the normal mode and the loss mode can be preliminarily adjusted to a request of the user.

Also, in the present invention, the first and the second step (means) respectively may include a third and a fourth step (means) determining whether or not the input signal data is silence signal data, and of invalidating the coarse search when the input signal data is determined to be the silence signal data.

Namely, since the processing amount in the pitch detection does not depend on a sound source inputted, packet loss compensation in the packet loss mode and a level determination of a signal inputted to the coarse search processor are added, thereby suppressing the processing amount in a case where a silent level continues in a signal to be decoded.

Furthermore, in the present invention, the first and the second step (means) respectively may include a fifth and a sixth step (means) invalidating and validating the third and the fourth step (means) respectively when the predetermined frequency of loops is a first value corresponding to a suppression request of a coarse search amount in the normal mode, and of contrarily validating and invalidating the third and the fourth step (means) when the predetermined frequency of loops is a second value corresponding to a suppression request of a coarse search amount in the packet loss mode.

Namely, when the suppression of the coarse search amount in the normal mode is desired by a user's request or the like, or when the same suppression in the packet loss mode is desired, a silence determination operation can be invalidated or disabled by using a first and a second predetermined frequencies of the loops, thereby enabling an unnecessary silence determination to be avoided.

As described above, the following effects can be obtained in the present invention:
The processing amount in the packet loss mode can be reduced.
Since the processing amount in the normal mode and the packet loss mode can be adjusted with the frequency of loops being a parameter, an optimum peak for a system can be adjusted, thereby resultantly enabling a system load to be reduced.
It becomes possible to reduce the processing amount more as the portion of silence data becomes larger. For example, in a one-way call such as voice guidance, a larger effect can be achieved. Supposing the silence data portions continue, the processing amount by the decoder is a main factor, so that regardless of presence/absence of the packet loss, operations are made possible by about 1 MHz.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a flowchart showing a principle of the present invention;

FIG. 2 is a block diagram showing an arrangement of an embodiment [1] of a voice data processing method and device according to the present invention;

FIG. 3 is a flowchart showing a coarse search example (in normal mode) in a coarse search processor 6 of FIG. 2;

FIG. 4 is a flowchart showing a coarse search example (packet loss mode) in a pitch detector 31 of FIG. 2;

FIG. 5 is a block diagram showing an arrangement of an embodiment [2] of a voice data processing method and device according to the present invention;

FIG. 6 is a block diagram showing an arrangement of an embodiment [3] of a voice data processing method and device according to the present invention;

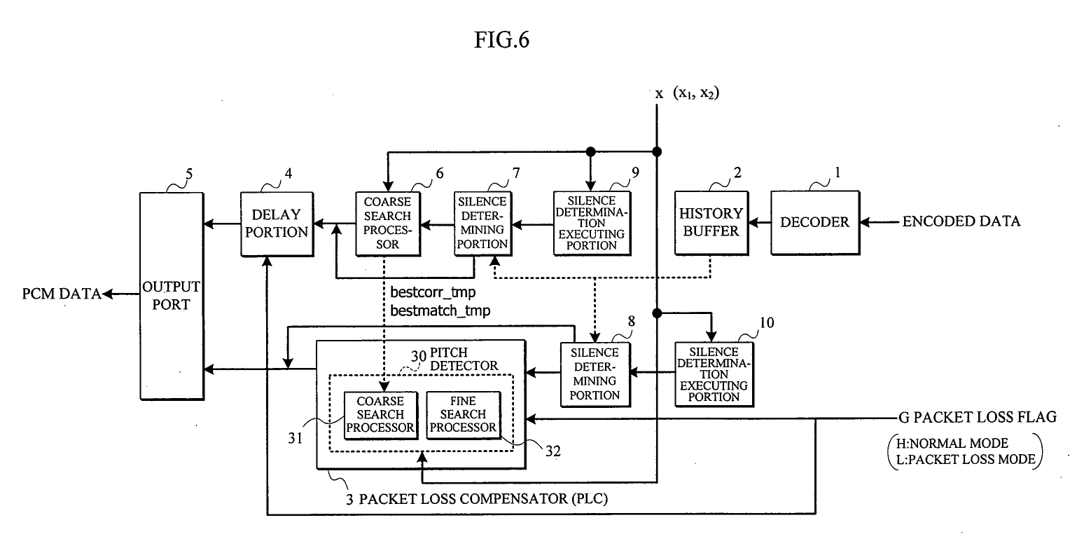

FIG. 7 is a block diagram showing a prior art arrangement based on G.711 Appendix I;

FIG. 8 is a block diagram showing an outline of pitch detection common to the present invention and the prior art example;

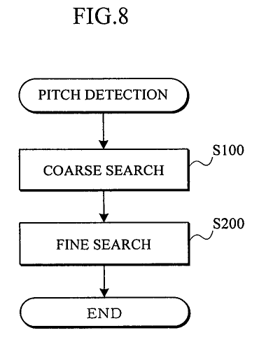

FIG. 9 is a diagram explaining a concept of pitch detection based on G.711 Appendix I;

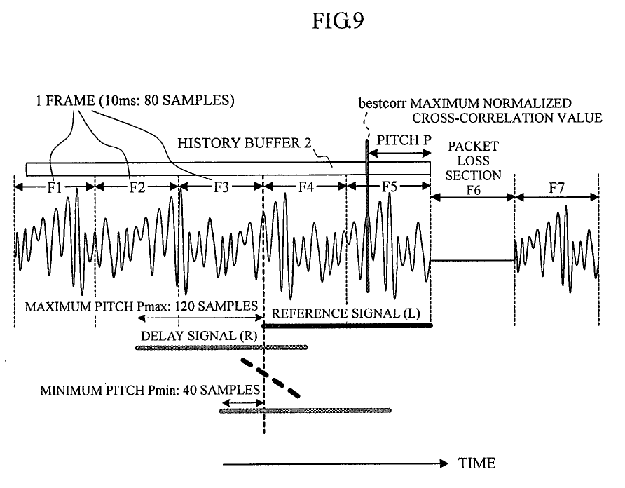

FIG. 10 is a diagram showing a state of frame data stored in a history buffer in the present invention and the prior art example; and

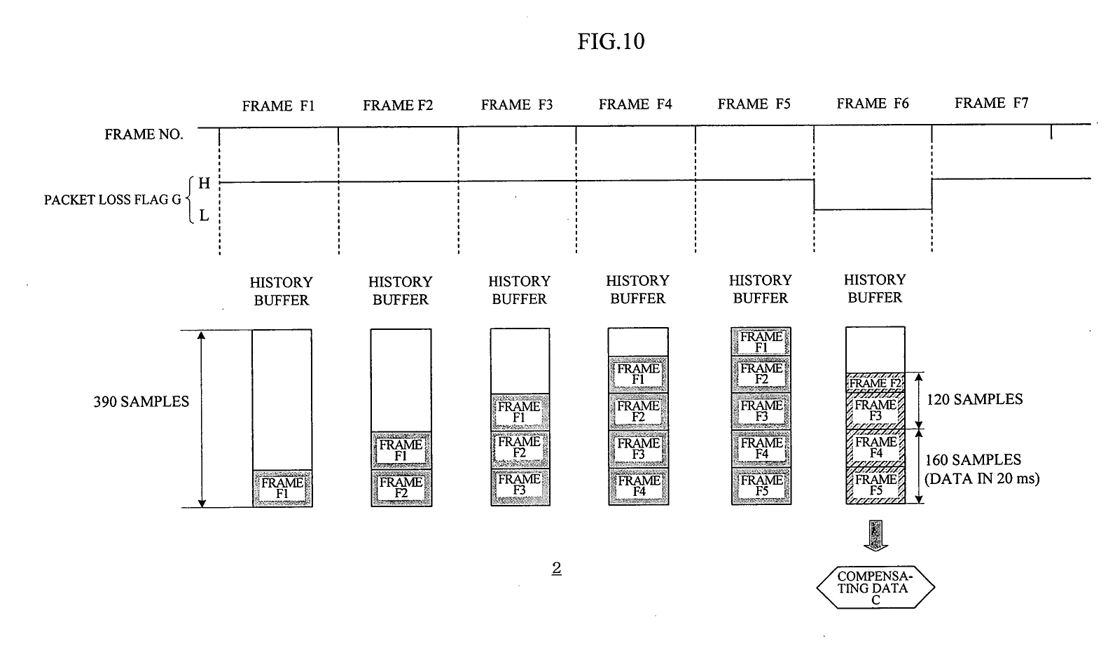

FIG. 11 is a flowchart showing a prior art coarse search example (packet loss mode).

### DESCRIPTION OF THE EMBODIMENTS

### Embodiment [1]

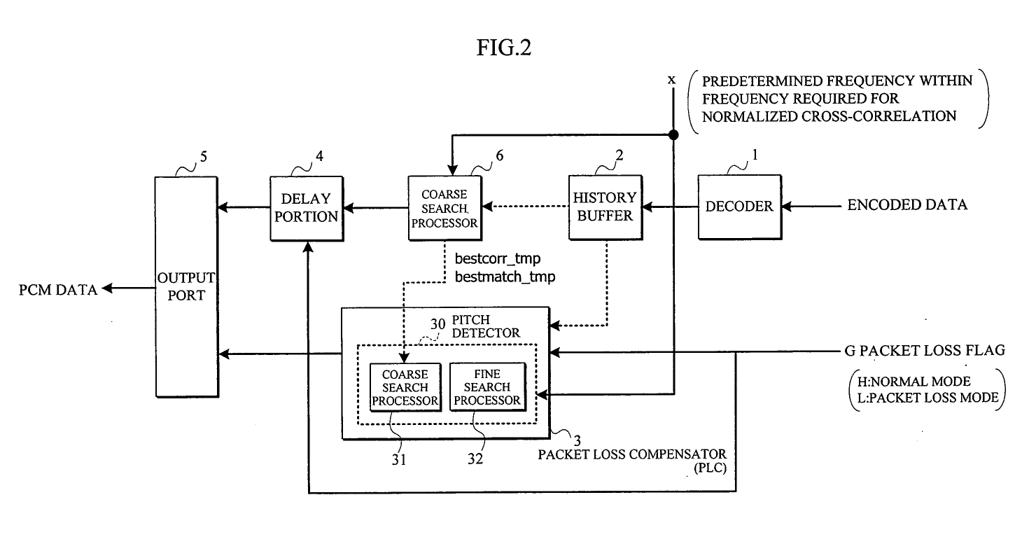

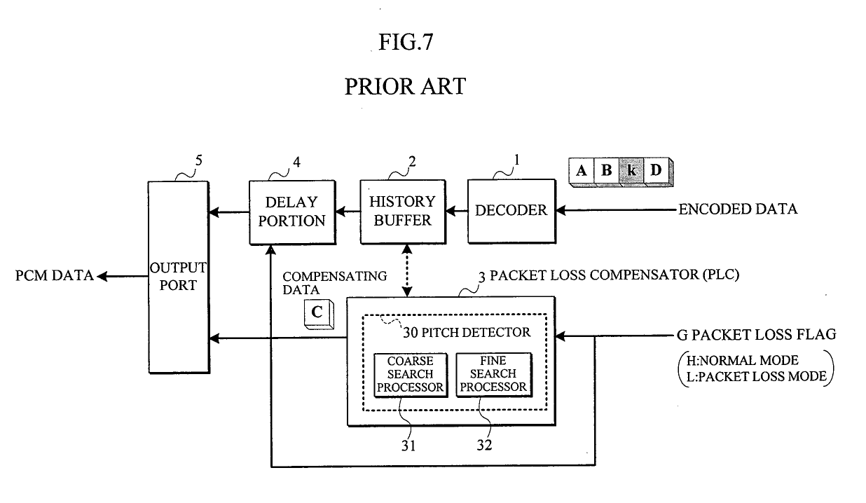

FIG. 2 shows an embodiment [1] of the voice data processing method and device according to the present invention. The difference between the embodiment [1] and the prior art example shown in FIG. 7 is that a coarse search processor 6 is provided between the history buffer 2 and the delay portion 4, a normalized cross-correlation peak value bestcorr_temp and a delay data value thereof bestmatch_temp stored in the coarse search processor 6 are provided to the coarse search processor 31 within the pitch detector 30 as initial values, and a predetermined frequency “x” of loops within a frequency (frequency of loops) required for a normalized cross-correlation calculation is provided to the coarse search processor 6 and the pitch detector 30.

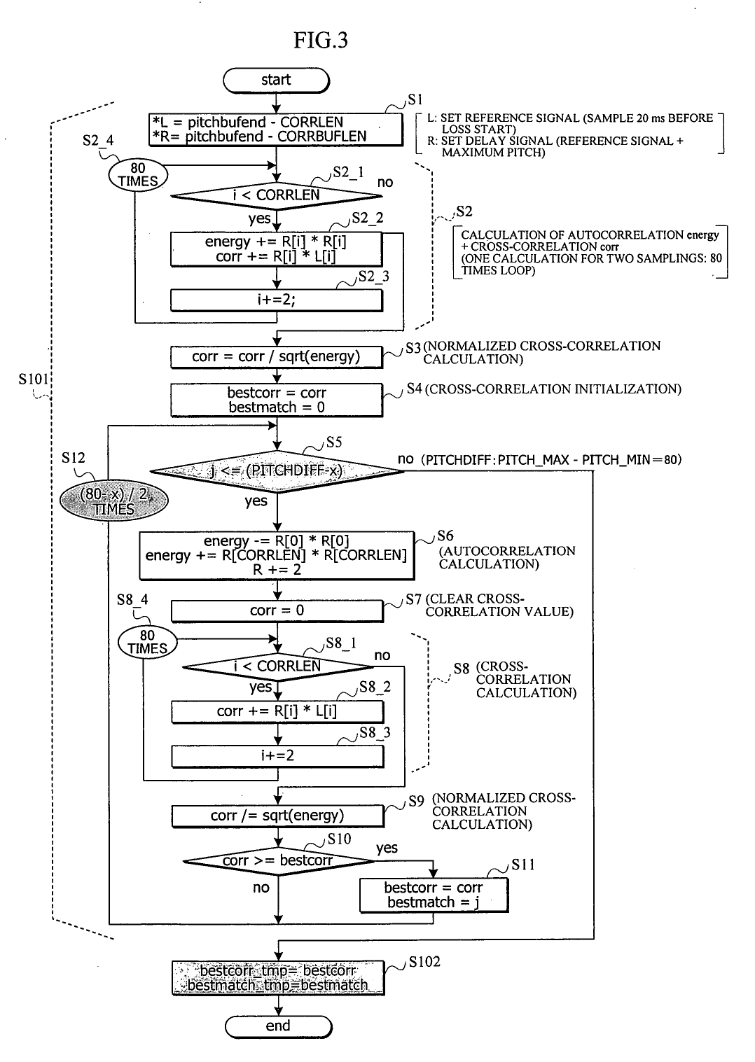

FIG. 3 shows an operation flow of the coarse search processor 6 in the embodiment [1] of such an arrangement.

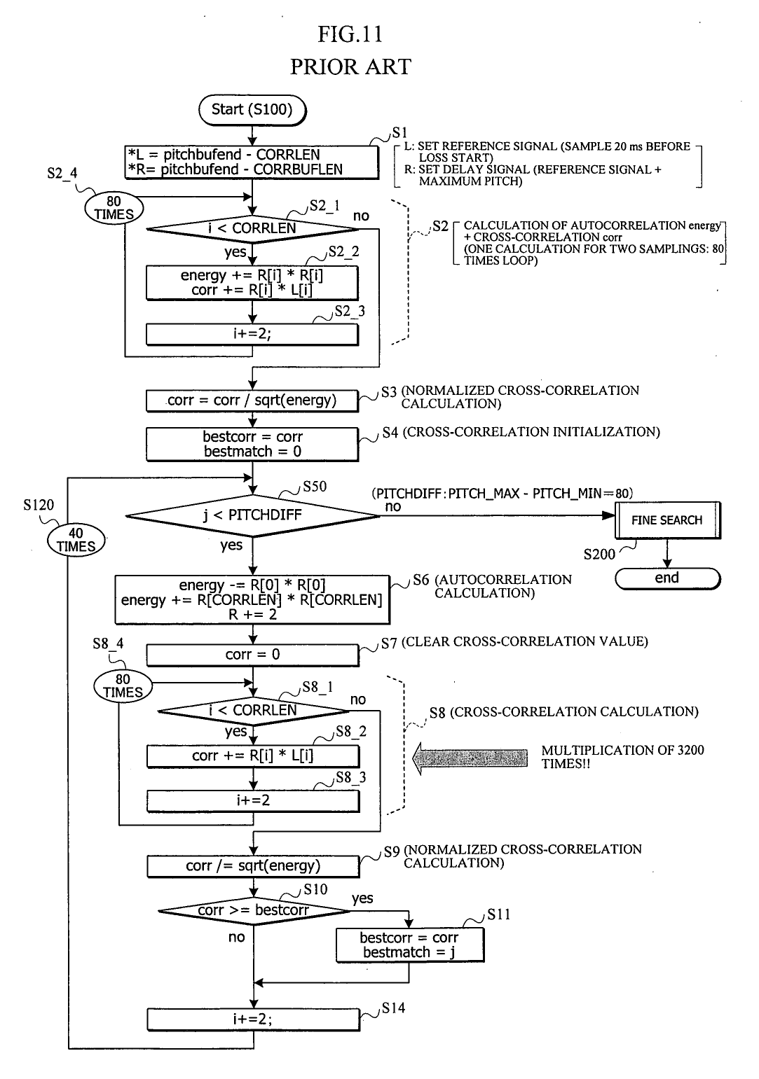

The flow of FIG. 3 shows a coarse search example in the normal mode. In this coarse search example, different from the prior art coarse search example (processing example in the packet loss mode by the coarse search processor 31) shown in FIG. 11, step S50 is replaced with step S5, step S120 is replaced with step S12, and the process proceeds to step S102, not to the fine search (at step S200) from step S5. Although not shown, in the coarse search processor 6 the processing in FIG. 3 is performed and concurrently the decode data of the history buffer 2 is transmitted to the delay portion 4 as it is.

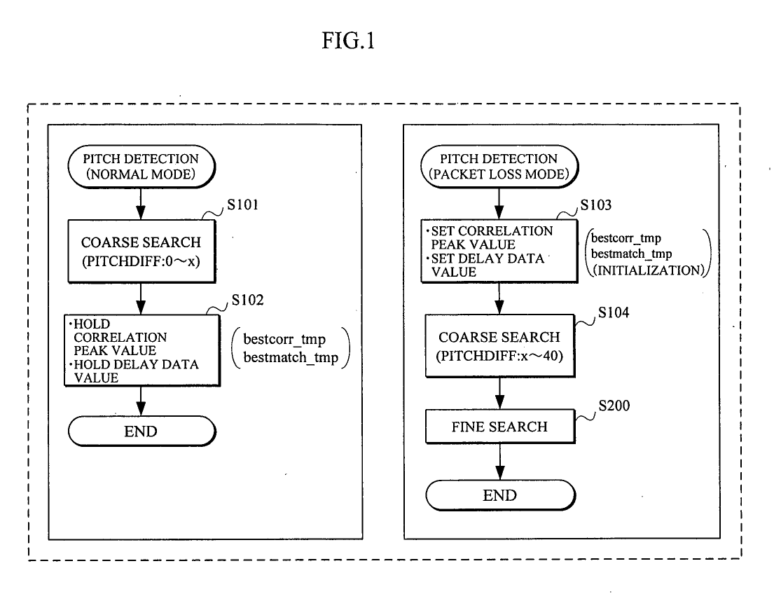

In this embodiment, the frequency of loops at steps S5-S12 is changed by using a variable “x” newly shown in FIGS. 1 and 2 in the normal mode. Specifically, the difference obtained by subtracting “x” from PITCHDIFF (difference between Pmax (120) and Pmin (40)=“80”) is made a frequency of loops (at step S12), whereby the processing amount is reduced, and intermediate results of the normalized cross-correlation peak value and the delay data value obtained within the loop are respectively held in buffers bestcorr_tmp and bestmatch_tmp (at step S102).

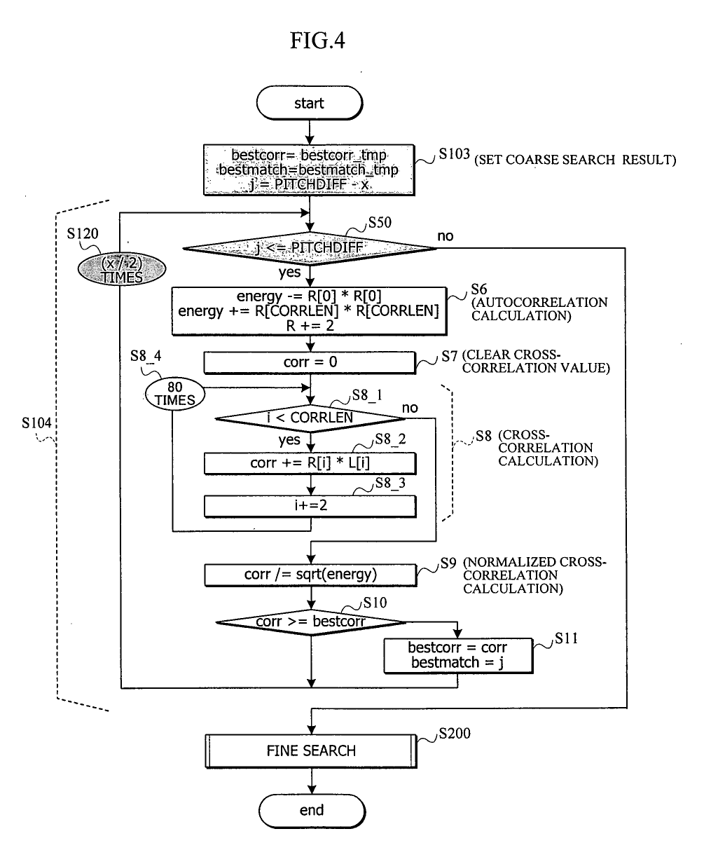

FIG. 4 is a flowchart showing a processing example in the packet loss mode by the coarse search processor 31 of the pitch detector 30 in the embodiment [1]. As described above, in the normal mode of FIG. 3, the normalized cross-correlation processing of the coarse search for a frequency of “PITCHDIFF-x” (at step S5) has been already executed. In the coarse search in the packet loss mode shown in FIG. 4, the normalized cross-correlation processings have only to be executed by the remaining frequency “x”.

Therefore, for the coarse search in the packet loss mode, as shown in FIG. 4, the initialization (at step S103) of variables is performed, PITCHDIFF-x is firstly set as an initial value of the frequency of loops (at step S103), and the normalized cross-correlation peak value and the delay data value calculated in the normal mode and respectively stored in the buffers bestcorr_tmp and bestmatch_tmp are set each as variables “bestcorr” and “bestmatch”. This is executed x/2 times (at step S120).

After the coarse search ends, the fine search is performed (at step S200), finishing the pitch detection.

It is supposed that there is a request from e.g. a system side for making a processing amount in the packet loss mode and a processing amount in the normal mode fixed. In this case, the predetermined frequency “x” shown in FIGS. 3 and 4 is set with “20” (pattern B) referring to the following table 1. It is to be noted that in this table 1, the processing amount in each pattern when the normalized cross-relation processing loop in the packet loss mode is changed, and request examples conceived from the system side where G711 Appendix I is incorporated are summarized.

TABLE 1

| | | PROCESSING AMOUNT (CYCLE) | | | | |
|---|---|---|---|---|---|---|
| | | NORMAL | | PACKET | | |
| | | MODE | EXECUTION | LOSS MODE | EXECUTION | |
| | FREQUENCY | (COARSE | OF SILENCE | [PITCH | OF SILENCE | |
| | OF LOOPS | SEARCH | DETERMINA- | DETECTION | DETERMINA- | SYSTEM |
| CASE | (X) | AMOUNT) | TION | AMOUNT] | TION | REQUEST CASE |
| PRESENT | 80 | α | NG | 39 MHz | OK | SUPPRESSION OF |
| SITUATION | | | | (4875 CYCLE) | | PROCESSING |
| | | | | | | AMOUNT IN |
| | | | | | | NORMAL MODE |
| PATTERN | 40 | 12.8 MHz + | * | 26.2 MHz | * | SUPPRESSION OF |
| A | | α (1600 | | (3275 CYCLE) | | PROCESSING |
| | | CYCLE + | | | | AMOUNT IN |
| | | α) | | | | PACKET LOSS |
| | | | | | | MODE TO 30 MHz |
| | | | | | | OR LESS. |
| PATTERN | 20 | 19.92 MHz + | * | 19.08 MHz | * | FIXATION OF |
| B | | α (2490 | | (2385 CYCLE) | | PROCESSING |
| | | CYCLE + | | | | AMOUNT IN |
| | | α) | | | | NORMAL MODE |
| | | | | | | & PACKET LOSS |
| | | | | | | MODE |
| PATTERN | 0 | 25.6 MHz + | OK | 13.4 MHz | NG | SUPPRESSION OF |
| C | | α (3200 | | (1675 CYCLE) | | PROCESSING |
| | | CYCLE + | | | | AMOUNT IN |
| | | α) | | | | PACKET LOSS |
| | | | | | | MODE |

α:PROCESSING AMOUND OF STEPS S1-S5 & S102 (ABOUT 1 MHz)
*DON'T CARE

In this case, the frequency of the normalized cross-correlation processing loops assumes PITCHDIFF−20=80−20=60 in the coarse search in the normal mode. Since the frequency of loops is added by 2 (at step S12), an actual frequency of loops of the normalized cross-correlation processing assumes 60/2=30 times. After the loop processing ends, the intermediate results of the normalized cross-correlation peak value “bestcorr” and the delay data value “bestmatch” are respectively held in the buffers bestcorr_tmp and bestmatch_tmp (at step S102).

Paying attention to the frequency of the normalized cross-correlation calculations in the coarse search of the normal mode, the frequency assumes 30×(product−sum of 81 times+product−difference of 1 time+division of 1 time)=product−sum of 2430 times+product-difference of 30 times+division of 30 times=2490 times. Since this processing is not performed in the normal mode of the prior art method, the frequency is increased by 2490×8 KHz (sampling frequency) cycle, that is 19.92 MHz.

Hereinafter, the processing in the packet loss mode will be described. In the above-mentioned normal mode, values held in the buffers bestcorr_tmp and bestmatch_tmp are respectively initialized to the bestcorr and the bestmatch (at step S103). Since the frequency of loops in the normalized cross-correlation is the remaining frequency “x”, “20” is set. Since the frequency of loops is added by 2, similar to the frequency of loops in the above-mentioned normal mode (at step S120), the frequency of loops assumes 10 times.

Paying attention to the frequency of the calculations in the normalized cross-correlation in the coarse search of the packet loss mode, the frequencies of the calculations according to the present invention and the prior art example are as follows:

$$Present invention : 10 ⨯ ( product - sum of 81 times + product - difference of 1 time + division of 1 time ) = product - sum of 810 times + product - difference of 10 times + division of 10 times = 830 times ( ⨯ 8 kHz = 6.64 MHz )$$

$$Prior art example : 40 ⨯ ( product - sum of 81 times + product - difference of 1 time + division of 1 time ) = product - sum of 3240 times + product - difference of 40 times + division of 40 times = 3320 times ( ⨯ 8 KHz = 26.56 MHz )$$

Thus, the present invention can achieve the effect of 75% of cycle reduction (−19.92 MHz) compared with the prior art example, so that the processing amount in the packet loss mode assumes 39 MHz−19.92 MHz=19.08 MHz.

As a result, as shown in Table 1,
Processing amount in the normal mode:19.92 MHz
Processing amount in the packet loss mode:19.08 MHz
   The both amounts are almost equal to each other. Therefore, it is possible to respond to the request from the system side.

### Embodiment [2]

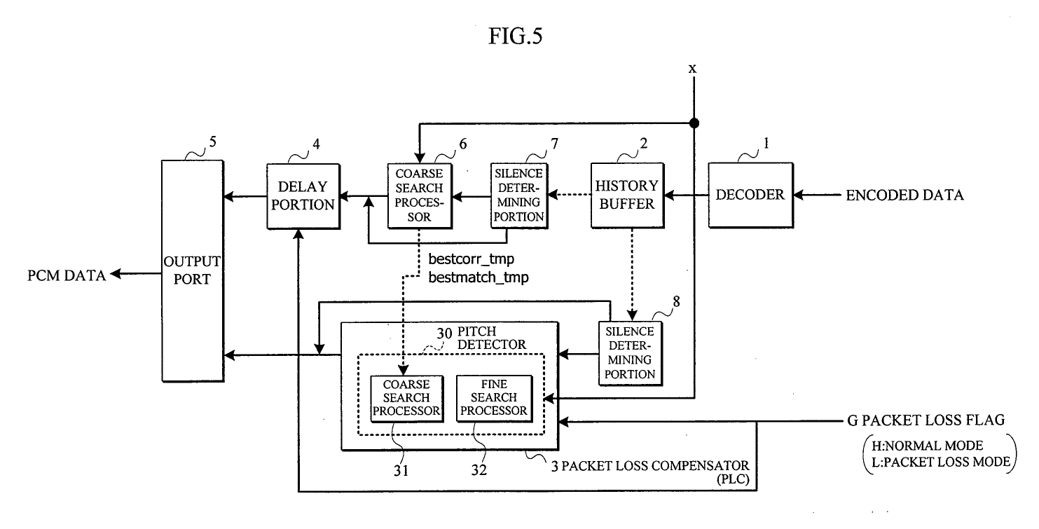

FIG. 5 shows an embodiment [2] of the voice data processing method and device according to the present invention. In the embodiment [2], silence determining portions 7 and 8 are added to the above-mentioned embodiment [1], respectively between the history buffer 2 and the coarse search processor 6, and between the history buffer 2 and the packet loss compensator 3.

It is now supposed that the present invention is mounted on a system where numerous calls are one-way calls such as voice guidance. In such a case, a silence part of data largely occupies input data, so that the processing is also performed to the silence data. In order to prevent this, a mechanism of performing a silence determination for the silence data and bypassing the coarse search and the packet loss compensation is provided, thereby enabling the processing to be efficiently performed.

In the history buffer 2, a signal decoded by the decoder 1 is stored, regardless of presence/absence of the packet loss. The packet loss compensator 3 performs the pitch detection and the generation of the packet loss compensating data C or the like from the decode data stored in the history buffer 2. However, when a signal level for 390 samples (390×125 μs) of the size of the history buffer 2 is at a silence by adding the silence determining portion 8 of the signal level in front of the packet loss compensator 3, the packet loss compensation is not performed.

Also, in the coarse search in the normal mode, the pitch detection is performed from the signal stored in the history buffer 2. When the signal level for the 390 samples (390×125 μs) of the size of the history buffer is at a silence by adding the silence determining portion 7 of the signal level in front of the coarse search in the normal mode, the coarse search is not performed.

### Embodiment [3]

As mentioned above, in the presence of a request of suppressing a processing load as much as possible in the normal mode and in the system where numerous calls are one-way calls from the system side, “x”=“80” is rendered, as shown in Table 1, in order to suppress the processing amount of the normal mode as much as possible. Also, the processings of only steps S1-S5 and S102 in FIG. 3 are performed in the normal mode, thereby reducing the processing load of the coarse search processor 6, and enabling operations by about 1 MHz.

However, by adding only the silence processors 7 and 8 as shown in FIG. 5, the processing amount by the silence processor 7 and 8 is only added, so that the processing load more than 1 MHz is actually imposed.

In the embodiment [3] of the present invention, silence determination executing portions 9 and 10 are respectively connected to the silence determining portions 7 and 8 added in the embodiment [2], and a predetermined frequency “x” of loops is provided to the silence determination executing portions 9 and 10, thereby further determining whether or not the silence determination should be performed. Therefore, the predetermined frequency “x” of loops includes the first value x1 and the second value x2.

In operation, when a packet loss flag G designates the normal mode, the data decoded by the decoder 1 is stored in the history buffer 2. Based on the data stored in the history buffer 2, the silence determining portion 7 performs a silence determination (detection), and validates or invalidates the coarse search processor 6. However, before the validation or invalidation, whether or not the silence determination itself should be performed is determined by the silence determination executing portion 9.

In the silence determination executing portion 9, e.g. the frequency “x” of loops during the pitch detection provided from a user is inputted as a parameter. In the presence of the request of suppressing the processing amount in the normal mode, as shown in Table 1, the frequency “x” of loops is set with “80” as the first value x1. In case of x1=80, the silence determination executing portion 9 makes the silence determination portion 7 do a through-operation, so that the decode data of the history buffer 2 is switched over so as to be provided as it is to the coarse search processor 6. Thus, the operation of the silence determining portion 6 is not executed, thereby enabling the processing amount to be suppressed to α.

Contrarily, in the presence of a request of suppressing the processing amount (pitch detection amount including fine search amount in this case) in the packet loss mode, from the value shown in Table 1 in the same way as the above, the frequency “x” of loops is set with “0” as the second value x2. In case of x2=0 in the silence execution determining portion 10, it is devised that the silence execution determining portion 10 makes the silence determining portion 8 do a through operation, and that the decode data of the history buffer 2 is switched over so as to be transmitted as it is to the packet loss compensator 3. Thus, steps S6-S11 and S120 of FIG. 4 are not executed, thereby enabling the processing amount to be suppressed to 13.4 MHz. Since step S12 is performed 40 times in FIG. 3 instead, 25.6 MHz is required for the coarse search amount of the normal mode.

Namely, when the processing amount of the silence determining portion 7 is larger than that of the packet loss compensator 3 in the packet loss mode, and also when data is voiced data, the data is validated or enabled. When the data is silence data for example, the data is passed through the silence determining portion 8 as it is, so that the packet loss compensation is performed without fail. In such a case, the processing amount assumes 13.4 MHz also from Table 1. However, when the data is passed through the silence determining portion 8 (x2=0) as it is, the packet loss compensation is bypassed with the determination result (silence). Therefore, the processing amount assumes only the processing amount of the silence determining portion 8.

It is to be noted that the present invention is not limited by the above-mentioned embodiments, and it is obvious that various modifications may be made by one skilled in the art based on the recitation of the claims.

What is claimed is:

1. A voice data processing method comprising:
a first step of, in a normal mode, decoding input signal data, repeating a calculation in coarse search used for a pitch detection by a predetermined frequency of loops within a required frequency of loops, based on history decode data, and holding a peak value of a normalized cross-correlation obtained by the calculation and a delay data value corresponding thereto; and
a second step of, in a packet loss mode, executing the pitch detection by repeating a calculation of a normalized cross-correlation in the coarse search by a remaining required frequency of loops, by using the peak value of the normalized cross-correlation and the delay data value, thereby generating compensating data.

2. The voice data processing method as claimed in claim 1, wherein the first and the second step respectively include a third and a fourth step of determining whether or not the input signal data is silence signal data, and of invalidating the coarse search when the input signal data is determined to be the silence signal data.

3. The voice data processing method as claimed in claim 2, wherein the first and the second step respectively include a fifth and a sixth step of invalidating and validating the third and the fourth step respectively when the predetermined frequency of loops is a first value corresponding to a suppression request of a coarse search amount in the normal mode, and of contrarily validating and invalidating the third and the fourth step when the predetermined frequency of loops is a second value corresponding to a suppression request of a coarse search amount in the packet loss mode.

4. The voice data processing method as claimed in claim 1, wherein the required frequency of loops corresponds to a number of samples from a maximum delay pitch to a minimum delay pitch for a reference signal.

5. A voice data processing device comprising:
a first means, in a normal mode, decoding input signal data, repeating a calculation in coarse search used for a pitch detection by a predetermined frequency of loops within a required frequency of loops, based on history decode data, and holding a peak value of a normalized cross-correlation obtained by the calculation and a delay data value corresponding thereto; and
a second means, in a packet loss mode, executing the pitch detection by repeating a calculation of a normalized cross-correlation in the coarse search by a remaining required frequency of loops, by using the peak value of the normalized cross-correlation and the delay data value, thereby generating compensating data.

6. The voice data processing device as claimed in claim 5, wherein the first and the second means respectively include a third and a fourth means determining whether or not the input signal data is silence signal data, and of invalidating the coarse search when the input signal data is determined to be the silence signal data.

7. The voice data processing device as claimed in claim 6, wherein the first and the second means respectively include a fifth and a sixth means invalidating and validating the third and the fourth means respectively when the predetermined frequency of loops is a first value corresponding to a suppression request of a coarse search amount in the normal mode, and of contrarily validating and invalidating the third and the fourth means when the predetermined frequency of loops is a second value corresponding to a suppression request of a coarse search amount in the packet loss mode.

8. The voice data processing device as claimed in claim 5, wherein the required frequency of loops corresponds to a number of samples from a maximum delay pitch to a minimum delay pitch for a reference signal.
